(19) United States
(12) Patent Application Publication
(10) Pub. No.: US 2020/0332147 A1
(43) Pub. Date: Oct. 22, 2020

(54) HARD COATINGS WITH HIGH CHEMICAL AND MECHANICAL STABILITY

(71) Applicant: Covestro Deutschland AG, Leverkusen (DE)

(72) Inventors: Dirk ACHTEN, Leverkusen (DE); Maria ALMATO GUITERAS, Barcelona (ES); Saskia BEUCK, Leverkusen (DE); Thomas FELLER, Solingen (DE); Florian GOLLING, Düsseldorf (DE)

(21) Appl. No.: 16/348,353

(22) PCT Filed: Oct. 18, 2017
(86) PCT No.: PCT/EP2017/076604

§ 371 Date: May 8, 2019

(30) Foreign Application Priority Data
Oct. 18, 2016 (EP) 16194348.5
Oct. 18, 2016 (EP) 16194353.5
Dec. 21, 2016 (EP) 16205635.2

(51) Int. Cl. C09D 175/04; C09D 5/00

(52) U.S. Cl. CPC C09D 175/04; C09D 5/00

(57) ABSTRACT

The present invention relates to coatings which have high stability with respect to chemical and mechanical impacts. Said coatings are obtainable by crosslinking polyisocyanates with a low oligomer content.

The present invention relates to coatings having high stability to chemical and mechanical effects. Said coatings are obtainable by the crosslinking of isocyanate-rich blends.

Conventional polyurethane coatings already have good chemical and mechanical stability (Polyurethane: Lacke, Kleb- und Dichtstoffe [Polyurethanes: Paints, Adhesives and Sealants] (Farbe und Lack edition), 1 Apr. 2007).

Ulrich Meier-Westhues; The solventless solution, M. Almató et al., European Coatings Journal Vol. 07/08, 2010).

Water-based polyurethane dispersions having good chemical stability to media that are used for removal of graffiti are described in WO 2009/029512 and in G. N. Manvi et al. (2012), “Isocyanurate based fluorinated polyurethane dispersion for anti-graffiti coatings” Progress in Organic Coatings 75: 139-146.

WO 2015/166983 describes the production of potting compounds for light-emitting diodes by the polymerization of oligomeric polyisocyanates. The polyisocyanurate plastics described therein are cured at at least 60° C.

U.S. Pat. No. 6,133,397 describes the use of oligomeric polyisocyanates for the production of coatings. Curing is effected at temperatures above 48° C. This is disadvantageous in many sectors, especially when relatively large components are to be coated, since ovens in a corresponding size are required for the purpose. Moreover, U.S. Pat. No. 6,133,397 does not give any pointers as to how high-stability coatings can be obtained from oligomeric polyisocyanates. More particularly, the study underlying this application has shown that the use of dibutyltin laurate as catalyst shown in U.S. Pat. No. 6,133,397 worsens the properties of the coating.

It was an object of the present invention to provide coatings that are superior to the conventional high-stability polyurethane coatings in terms of their stability to chemical or mechanical effects. Moreover, coatings of this kind—unlike the polyisocyanurate plastics already known—should be curable even at room temperature.

In one embodiment, the invention relates to a process for producing surface coatings having a high hardness and high mechanical and/or chemical stability, comprising the process steps of
a) providing a polyisocyanate composition A), where the isocyanate content is at least 15% by weight;
b) applying the polyisocyanate composition A) to a surface; and
c) catalytically crosslinking the polyisocyanate composition A) in the presence of at least one catalyst B),
with the proviso that the reaction mixture formed from the polyisocyanate composition A) and the at least one catalyst B) contains not more than 0.5% by weight of organic and inorganic iron, lead, tin, bismuth and zinc compounds.

In a preferred embodiment of the present invention, the at least one catalyst is mixed with the polyisocyanate composition A) before it is applied to the surface in process step b).

In the meantime, however, it has been found that coatings having good properties can be obtained even when the polyisocyanate composition A) and a composition comprising at least one catalyst B) are applied successively to the surface in separate steps. Consequently, in a further preferred embodiment of the present invention, the polyisocyanate composition A) and a composition comprising at least one catalyst B) are applied successively to the surface in any sequence. The presence of a catalyst B) in the polyisocyanate composition A) prior to the application to the surface in process step B) is thus not required. It should be noted here that, where a coating of the surface is desired, both the polyisocyanate composition A) and the composition comprising at least one catalyst B) have to be applied.

Irrespective of whether the catalyst B) is or is not already present in the polyisocyanate composition A) prior to the application, the polyisocyanate composition A) in combination with at least one catalyst B) forms a “reaction mixture”, meaning that the polyisocyanate A) and at least one catalyst B) are in spatial proximity, such that the catalyst B) can bring about crosslinking of the polyisocyanates present in the polyisocyanate A).

As apparent from example 2 (table 4), the use of organic or inorganic iron, lead, tin, bismuth or zinc compounds leads to coatings having lower pendulum hardness. Consequently, the reaction mixture as present on commencement of the catalytic crosslinking in process step c) contains at most 0.5% by weight, more preferably at most 0.2% by weight, even more preferably at most 0.1% by weight and more preferably only at most 0.01% by weight of organic and inorganic iron, lead, tin, bismuth and zinc compounds. The aforementioned proportions are based on the solids content of the reaction mixture present on commencement of process step c), i.e. the weight of the reaction mixture minus water and organic solvents.

The term “polyisocyanate” as used here is a collective term for compounds containing two or more isocyanate groups in the molecule (this is understood by the person skilled in the art to mean free isocyanate groups of the general structure —N═C═O). The simplest and most important representatives of these polyisocyanates are the diisocyanates. These have the general structure O═C═N—R—N═C═O where R typically represents aliphatic, alicyclic and/or aromatic radicals.

Because of the polyfunctionality (≥2 isocyanate groups), it is possible to use polyisocyanates to produce a multitude of polymers (e.g. (e.g. polyurethanes, polyureas and polyisocyanurates) and low molecular weight compounds (for example those having uretdione, isocyanurate, allophanate, biuret, iminooxadiazinedione and/or oxadiazinetrione structure).

The term “polyisocyanates” in this application refers equally to monomeric and/or oligomeric polyisocyanates. For the understanding of many aspects of the invention, however, it is important to distinguish between monomeric diisocyanates and oligomeric polyisocyanates. Where reference is made in this application to “oligomeric polyisocyanates”, this means polyisocyanates formed from at least two monomeric diisocyanate molecules, i.e. compounds that constitute or contain a reaction product formed from at least two monomeric diisocyanate molecules.

The preparation of oligomeric polyisocyanates from monomeric diisocyanates is also referred to here as modification of monomeric diisocyanates. This “modification” as used here means the reaction of monomeric diisocyanates to give oligomeric polyisocyanates having uretdione, isocyanurate, allophanate, biuret, iminooxadiazinedione and/or oxadiazinetrione structure.

For example, hexamethylene diisocyanate (HDI) is a “monomeric diisocyanate” since it contains two isocyanate groups and is not a reaction product of at least two polyisocyanate molecules:

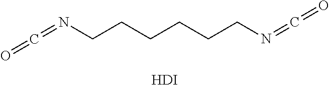

Reaction products which are formed from at least two HDI molecules and still have at least two isocyanate groups, by contrast, are “oligomeric polyisocyanates” within the context of the invention. Representatives of such “oligomeric polyisocyanates” are, proceeding from monomeric HDI, for example, HDI isocyanurate and HDI biuret, each of which is formed from three monomeric HDI units:

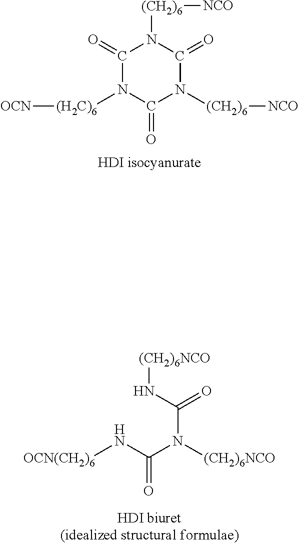

“Polyisocyanate composition A)” in the context of the invention refers to the isocyanate component in the initial reaction mixture. In other words, this is the sum total of all compounds in the initial reaction mixture that have isocyanate groups. The polyisocyanate composition A) is thus used as reactant in the process of the invention. When reference is made here to “polyisocyanate composition A)”, especially to “providing the polyisocyanate composition A)”, this means that the polyisocyanate composition A) exists and is used as reactant.

According to the invention, the proportion by weight of isocyanate groups based on the total amount of the polyisocyanate composition A) is at least 15% by weight.

In principle, monomeric and oligomeric polyisocyanates are equally suitable for use in the polyisocyanate composition A) of the invention. Consequently, the polyisocyanate composition A) may consist essentially of monomeric polyisocyanates or essentially of oligomeric polyisocyanates. It may alternatively comprise oligomeric and monomeric polyisocyanates in any desired mixing ratios.

In a preferred embodiment of the invention, the polyisocyanate composition A) used as reactant in the trimerization has a low level of monomers (i.e. a low level of monomeric diisocyanates) and already contains oligomeric polyisocyanates. The expressions “having a low level of monomers” and “having a low level of monomeric diisocyanates” are used here synonymously in relation to the polyisocyanate composition A).

Results of particular practical relevance are established when the polyisocyanate composition A) has a proportion of monomeric diisocyanates in the polyisocyanate composition A) of not more than 20% by weight, especially not more than 15% by weight or not more than 10% by weight, based in each case on the weight of the polyisocyanate composition A). Preferably, the polyisocyanate composition A) has a content of monomeric diisocyanates of not more than 5% by weight, especially not more than 2.0% by weight, more preferably not more than 1.0% by weight, based in each case on the weight of the polyisocyanate composition A). Particularly good results are established when the polymer composition A) is essentially free of monomeric diisocyanates. “Essentially free” means here that the content of monomeric diisocyanates is not more than 0.5% by weight, based on the weight of the polyisocyanate composition A).

In a particularly preferred embodiment of the invention, the polyisocyanate composition A) consists entirely or to an extent of at least 80%, 85%, 90%, 95%, 98%, 99% or 99.5% by weight, based in each case on the weight of the ipolyisocyanate composition A), of oligomeric polyisocyanates. Preference is given here to a content of oligomeric polyisocyanates of at least 99% by weight. This content of oligomeric polyisocyanates relates to the polyisocyanate composition A) as provided. In other words, the oligomeric polyisocyanates are not formed as intermediate during the process of the invention, but are already present in the polyisocyanate composition A) used as reactant on commencement of the reaction.

Polyisocyanate compositions which have a low level of monomers or are essentially free of monomeric isocyanates can be obtained by conducting, after the actual modification reaction, in each case, at least one further process step for removal of the unconverted excess monomeric diisocyanates. This removal of monomers can be effected in a particularly practical manner by processes known per se, preferably by thin-film distillation under high vacuum or by extraction with suitable solvents that are inert toward isocyanate groups, for example aliphatic or cycloaliphatic hydrocarbons such as pentane, hexane, heptane, cyclopentane or cyclohexane.

In a preferred embodiment of the invention, the polyisocyanate composition A) of the invention is obtained by modifying monomeric diisocyanates with subsequent removal of unconverted monomers.

In a particular embodiment of the invention, a polyisocyanate composition A) having a low level of monomers, however, contains an extra monomeric diisocyanate. In this context, “extra monomeric diisocyanate” means that it differs from the monomeric diisocyanates which have been used for preparation of the oligomeric polyisocyanates present in the polyisocyanate composition A).

An addition of extra monomeric diisocyanate may be advantageous for achievement of special technical effects, for example an exceptional hardness. Results of particular practical relevance are established when the polyisocyanate composition A) has a proportion of extra monomeric diisocyanate in the polyisocyanate composition A) of not more than 20% by weight, especially not more than 15% by weight or not more than 10% by weight, based in each case on the weight of the polyisocyanate composition A). Preferably, the polyisocyanate composition A) has a content of extra monomeric diisocyanate of not more than 5% by weight, especially not more than 2.0% by weight, more preferably not more than 1.0% by weight, based in each case on the weight of the polyisocyanate composition A).

In a further particular embodiment of the process of the invention, the polyisocyanate composition A) contains monomeric monoisocyanates or monomeric isocyanates having an isocyanate functionality greater than two, i.e. having more than two isocyanate groups per molecule. The addition of monomeric monoisocyanates or monomeric isocyanates having an isocyanate functionality greater than two has been found to be advantageous in order to influence the network density of the coating. Results of particular practical relevance are established when the polyisocyanate composition A) has a proportion of monomeric monoisocyanates or monomeric isocyanates having an isocyanate functionality greater than two in the polyisocyanate composition A) of not more than 20% by weight, especially not more than 15% by weight or not more than 10% by weight, based in each case on the weight of the polyisocyanate composition A). Preferably, the polyisocyanate composition A) has a content of monomeric monoisocyanates or monomeric isocyanates having an isocyanate functionality greater than two of not more than 5% by weight, especially not more than 2.0% by weight, more preferably not more than 1.0% by weight, based in each case on the weight of the polyisocyanate composition A). Preferably, no monomeric monoisocyanate or monomeric isocyanate having an isocyanate functionality greater than two is used in the trimerization reaction of the invention.

The oligomeric polyisocyanates may, in accordance with the invention, especially have uretdione, isocyanurate, allophanate, biuret, iminooxadiazinedione and/or oxadiazinetrione structure. In one embodiment of the invention, the oligomeric polyisocyanates have at least one of the following oligomeric structure types or mixtures thereof:

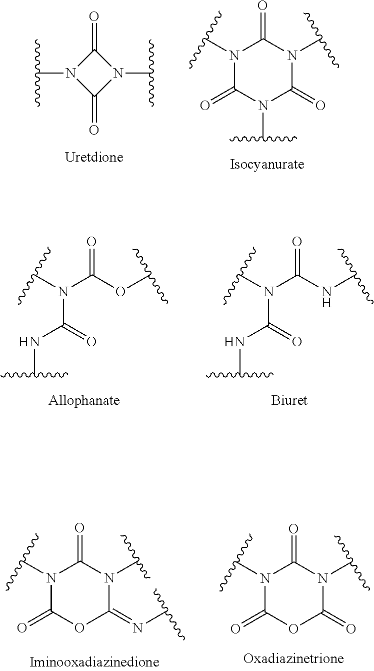 [SMILES: *N1C(=O)N(*)C1=O ; *n1c(=O)n(*)c(=O)n(*)c1=O ; *NC(=O)N(*)C(=O)O* ; *NC(=O)N(*)C(=O)N* ; */N=c1/oc(=O)n(*)c(=O)n1* ; *n1c(=O)oc(=O)n(*)c1=O]

In a preferred embodiment of the invention, a polymer composition A) wherein the isocyanurate structure component is at least 50 mol %, preferably at least 60 mol %, more preferably at least 70 mol %, even more preferably at least 80 mol %, even more preferably still at least 90 mol % and especially preferably at least 95 mol %, based on the sum total of the oligomeric structures from the group consisting of uretdione, isocyanurate, allophanate, biuret, iminooxadiazinedione and oxadiazinetrione structure present in the polyisocyanate composition A), is used.

In a further embodiment of the invention, in the process of the invention, a polyisocyanate composition A) containing, as well as the isocyanurate structure, at least one further oligomeric polyisocyanate having uretdione, biuret, allophanate, iminooxadiazinedione and oxadiazinetrione structure and mixtures thereof is used.

The proportions of uretdione, isocyanurate, allophanate, biuret, iminooxadiazinedione and/or oxadiazinetrione structure in the polyisocyanates A) can be determined, for example, by NMR spectroscopy. It is possible here with preference to use 13C NMR spectroscopy, preferably in proton-decoupled form, since the oligomeric structures mentioned give characteristic signals.

Irrespective of the underlying oligomeric structure (uretdione, isocyanurate, allophanate, biuret, iminooxadiazinedione and/or oxadiazinetrione structure), the oligomeric polyisocyanate composition A) for use in the process of the invention and/or the oligomeric polyisocyanates present therein preferably have/has a (mean) NCO functionality of 2.0 to 5.0, preferably of 2.3 to 4.5.

Results of particular practical relevance are established when the polyisocyanate composition A) for use in accordance with the invention has a content of isocyanate groups of 8.0% to 28.0% by weight, preferably of 14.0% to 25.0% by weight, based in each case on the weight of the polyisocyanate composition A).

Preparation processes for the oligomeric polyisocyanates having uretdione, isocyanurate, allophanate, biuret, iminooxadiazinedione and/or oxadiazinetrione structure that are to be used in accordance with the invention in the polyisocyanate composition A) are described, for example, in J. Prakt. Chem. 336 (1994) 185-200, in DE-A 1 670 666, DE-A 1 954 093, DE-A 2 414 413, DE-A 2 452 532, DE-A 2 641380, DE-A 3 700 209, DE-A 3 900 053 and DE-A 3 928 503 or in EP-A 0 336 205, EP-A 0 339 396 and EP-A 0 798 299.

In an additional or alternative embodiment of the invention, the polyisocyanate composition A) of the invention is defined in that it contains oligomeric polyisocyanates which have been obtained from monomeric diisocyanates, irrespective of the nature of the modification reaction used, with observation of an oligomerization level of 5% to 45%, preferably 10% to 40%, more preferably 15% to 30%. “Oligomerization level” is understood here to mean the percentage of isocyanate groups originally present in the starting mixture which are consumed during the preparation process to form uretdione, isocyanurate, allophanate, biuret, iminooxadiazinedione and/or oxadiazinetrione structures.

Suitable polyisocyanates for production of the polyisocyanate composition A) for use in the process of the invention and the monomeric and/or oligomeric polyisocyanates present therein are any desired polyisocyanates obtainable in various ways, for example by phosgenation in the liquid or gas phase or by a phosgene-free route, for example by thermal urethane cleavage. Particularly good results are established when the polyisocyanates are monomeric diisocyanates. Preferred monomeric diisocyanates are those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates. Further diisocyanates that are likewise suitable can additionally be found, for example, in Justus Liebigs Annalen der Chemie, volume 562 (1949) p. 75-136.

Suitable monomeric monoisocyanates which can optionally be used in the polyisocyanate composition A) are, for example, n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- or 4-methylcyclohexyl isocyanate or any desired mixtures of such monoisocyanates. An example of a monomeric isocyanate having an isocyanate functionality greater than two which can optionally be added to the polyisocyanate composition A) is 4-isocyanatomethyloctane 1,8-diisocyanate (triisocyanatononane; TIN).

In one embodiment of the invention, the polyisocyanate composition A) contains not more than 30% by weight, especially not more than 20% by weight, not more than 15% by weight, not more than 10% by weight, not more than 5% by weight or not more than 1% by weight, based in each case on the weight of the polyisocyanate composition A), of aromatic polyisocyanates. As used here, “aromatic polyisocyanate” means a polyisocyanate having at least one aromatically bonded isocyanate group.

Aromatically bonded isocyanate groups are understood to mean isocyanate groups bonded to an aromatic hydrocarbyl radical.

In a preferred embodiment of the process of the invention, a polyisocyanate composition A) having exclusively aliphatically and/or cycloaliphatically bonded isocyanate groups is used.

Aliphatically and cycloaliphatically bonded isocyanate groups are respectively understood to mean isocyanate groups bonded to an aliphatic and cycloaliphatic hydrocarbyl radical.

In another preferred embodiment of the process of the invention, a polyisocyanate composition A) consisting of or comprising one or more oligomeric polyisocyanates is used, where the one or more oligomeric polyisocyanates has/have exclusively aliphatically and/or cycloaliphatically bonded isocyanate groups.

In a further embodiment of the invention, the polyisocyanate composition A) consists to an extent of at least 70%, 80%, 85%, 90%, 95%, 98% or 99% by weight, based in each case on the weight of the polyisocyanate composition A), of polyisocyanates having exclusively aliphatically and/or cycloaliphatically bonded isocyanate groups. Practical experiments have shown that particularly good results can be achieved with polyisocyanate compositions A) in which the oligomeric polyisocyanates present therein have exclusively aliphatically and/or cycloaliphatically bonded isocyanate groups.

In a particularly preferred embodiment of the process of the invention, a polyisocyanate composition A) is used which consists of or comprises one or more oligomeric polyisocyanates, where the one or more oligomeric polyisocyanates is/are based on 1,4-diisocyanatobutane (BDI), 1,5-diisocyanatopentane (PDI), 1,6-diisocyanatohexane (HDI), isophorone diisocyanate (IPDI) or 4,4′-diisocyanatodicyclohexylmethane (H12MDI) or mixtures thereof.

In a further embodiment of the invention, in the process of the invention, polyisocyanate compositions A) having a viscosity greater than 500 mPas and less than 200 000 mPas, preferably greater than 1000 mPas and less than 100 000 mPas, more preferably greater than 1000 mPas and less than 50 000 mPas, measured according to DIN EN ISO 3219 at 21° C., are used.

Since conventional polyurethane coatings have fewer advantageous properties than the coatings obtainable by the process of the invention, the formation of urethane groups in the context of the process is undesirable. For this reason, not more than 50%, more preferably not more than 30%, even more preferably not more than 20% and most preferably not more than 10% isocyanate-reactive groups are added to the polyisocyanate composition A). It is preferable that the other components of the reaction mixture present on commencement of process step c) also have a content of isocyanate-reactive groups low enough that the overall reaction mixture at the start of process step c) contains a maximum of 50% by weight, more preferably a maximum of 30% by weight, even more preferably a maximum of 20% by weight and most preferably a maximum of 10% by weight isocyanate-reactive groups. This corresponds to molar ratios in the reaction mixture on commencement of process step c) of isocyanate-reactive groups to isocyanate groups of at most 0.5:1, 0.3:1, 0.2:1 or 0.1:1. The aforementioned proportions are calculated as the molar ratio of isocyanate groups to isocyanate-reactive groups. Isocyanate-reactive groups as comprehended in this application are hydroxyl groups, amino groups and thiol groups.

The polyisocyanate composition A) can be applied by different methods that are known per se. For production of coatings, for example paints, it is possible to apply reaction mixtures comprising the catalyst B and the polyisocyanate composition A) in one or more layers to any desired substrates, for example by spraying, painting, dipping, casting, flow-coating, or with the aid of brushes, rollers or coating bars, or by printing techniques, preferably screenprinting, valvejet or piezo printing. Prior to the coating, the substrate can optionally also be provided with customary primers.

Preferably, the surface to be coated consists essentially of a material selected from the group consisting of mineral substances, metal, rigid plastics, flexible plastics, textiles, leather, wood, wood derivatives and paper. More preferably, the surface to be coated consists essentially of a material selected from the group consisting of metal, wood, glass, stone, ceramic materials, concrete, rigid plastics, flexible plastics, textiles, leather and paper.

A surface consists “essentially” of one of the aforementioned materials when not more than 50% of the area, preferably not more than 30% of the area and most preferably not more than 20% of the area that comes into contact with the polyisocyanate composition A) consists of an extraneous material.

It is further preferable to coat the outer layer and/or the decorative paper of a laminate floor by the process of the invention.

The polyisocyanate composition A) is preferably applied in a layer thickness of 1 μm to 300 μm and more preferably of 50 μm to 100 μm.

The term “catalytic crosslinking of the polyisocyanate composition A” refers to the further crosslinking of the oligomeric and any monomeric polyisocyanates present in the polyisocyanate composition A). This is effected in the presence of at least one suitable catalyst B).

It is preferable to contact the polyisocyanate composition A) with the catalyst composition B) prior to process step b). Since the oligomeric polyisocyanates of the invention, after mixing with the catalyst compositions of the invention, have pot lives between 1 minute and 720 minutes, the two components are appropriately contacted with one another prior to process step b) only within the aforementioned period. This is preferably effected by mixing the two components and can be accomplished by all methods and apparatuses known for the application of two-component systems in the field of polyurethane coatings. However, the application of polyisocyanate composition A) and catalyst composition B) is also possible in separate layers as described above.

Preferably, the polyisocyanate composition A) and the catalyst composition B) are contacted with one another not more than 720 minutes, more preferably not more than 300 minutes, even more preferably not more than 60 minutes and most preferably not more than 10 minutes prior to process step b).

In a preferred embodiment of the present invention, the catalytic crosslinking is effected at room temperature. The term “room temperature” preferably denotes a temperature range between 5° C. and 47° C., more preferably between 10° C. and 35° C. and most preferably between 15° C. and 25° C.

When the catalysts of the invention are used, the crosslinking reaction preferably sets in without further thermal activation of the catalyst above 47° C.

In another preferred embodiment of the present invention, the catalytic crosslinking is effected within a temperature range between 47° C. and 250° C., more preferably between 80° C. and 200° C.

In a preferred embodiment of the present invention, during the catalytic crosslinking in process step c), the amount of the isocyanurate groups in the polyisocyanate composition A) increases by at least 10%, preferably at least 30%, more preferably at least 50%, even more preferably at least 100% and most preferably at least 200%. The yardstick here is the amount of isocyanurate groups that was present in the polyisocyanate composition A) provided in process step a).

Suitable catalysts B) for the process of the invention are in principle all compounds that accelerate the addition of isocyanurate groups to give isocyanurate, uretdione, allophanate, biuret, iminooxadiazinedione and oxadiazinetrione structures and urea and urethane groups and hence crosslink the molecules containing isocyanate groups that are present in the polyisocyanate composition A). Preferably, the formulations of the invention crosslink to form isocyanurate, uretdione and urea groups.

Suitable catalysts B) for the process of the invention are, for example, simple tertiary amines, for example triethylamine, tributylamine, N,N-dimethylaniline, N-ethylpiperidine or N,N′-dimethylpiperazine. Suitable catalysts are also the tertiary hydroxyalkylamines described in GB 2 221 465, for example triethanolamine, N-methyldiethanolamine, dimethylethanolamine, N-isopropyldiethanolamine and 1-(2-hydroxyethyl)pyrrolidine, or the catalyst systems known from GB 2 222 161 that consist of mixtures of tertiary bicyclic amines, for example DBU, with simple aliphatic alcohols of low molecular weight.

Further trimerization catalysts B suitable for the process of the invention are, for example, the quaternary ammonium hydroxides known from DE-A 1 667 309, EP-A 0 013 880 and EP-A 0 047 452, for example tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2]octane hydroxide (monoadduct of ethylene oxide and water with 1,4-diazabicyclo[2.2.2]octane), the quaternary hydroxyalkylammonium hydroxides known from EP-A 37 65 or EP-A 10 589, for example N,N,N-trimethyl-N-(2-hydroxyethyl)ammonium hydroxide, the trialkylhydroxylalkylammonium carboxylates that are known from DE-A 2631733, EP-A 0 671426, EP-A 1 599 526 and U.S. Pat. No. 4,789,705, for example N,N,N-trimethyl-N-2-hydroxypropylammonium p-tert-butylbenzoate and N,N,N-trimethyl-N-2-hydroxypropylammonium 2-ethylhexanoate, the quaternary benzylammonium carboxylates known from EP-A 1 229 016, such as N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium 2-ethylhexanoate or N,N,N-tributyl-N-(4-methoxybenzyl)ammonium pivalate, the tetrasubstituted ammonium α-hydroxycarboxylates known from WO 2005/087828, for example tetramethylammonium lactate, the quaternary ammonium or phosphonium fluorides known from EP-A 0 339 396, EP-A 0 379 914 and EP-A 0 443 167, for example N-methyl-N,N,N-trialkylammonium fluorides with C8-C10-alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride, the quaternary ammonium and phosphonium polyfluorides known from EP-A 0 798 299, EP-A 0 896 009 and EP-A 0 962 455, for example benzyltrimethylammonium hydrogen polyfluoride, the tetraalkylammonium alkylcarbonates which are known from EP-A 0 668 271 and are obtainable by reaction of tertiary amines with dialkyl carbonates, or betaine-structured quaternary ammonioalkyl carbonates, the quaternary ammonium hydrogencarbonates known from WO 1999/023128, such as choline bicarbonate, the quaternary ammonium salts which are known from EP 0 102 482 and are obtainable from tertiary amines and alkylating esters of phosphorus acids, examples of such salts being reaction products of triethylamine, DABCO or N-methylmorpholine with dimethyl methanephosphonate, or the tetrasubstituted ammonium salts of lactams that are known from WO 2013/167404, for example trioctylammonium caprolactamate or dodecyltrimethylammonium caprolactamate.

Likewise suitable as crosslinking catalysts B) for the process of the invention are a multitude of different metal compounds. Suitable examples are the octoates and naphthenates of manganese, cobalt, nickel, copper, zirconium or cerium or mixtures thereof with acetates of lithium, sodium, potassium, calcium or barium that are described as catalysts in DE-A 3 240 613, the sodium and potassium salts of linear or branched alkanecarboxylic acids having up to 10 carbon atoms that are known from DE-A 3 219 608, for example of propionic acid, butyric acid, valeric acid, caproic acid, heptanoic acid, caprylic acid, pelargonic acid, capric acid and undecylenoic acid, the alkali metal or alkaline earth metal salts of aliphatic, cycloaliphatic or aromatic mono- and polycarboxylic acids having 2 to 20 carbon atoms that are known from EP-A 0 100 129, for example sodium or potassium benzoate, the alkali metal phenoxides known from GB-A 1 391 066 and GB-A 1 386 399, for example sodium or potassium phenoxide, the alkali metal and alkaline earth metal oxides, hydroxides, carbonates, alkoxides and phenoxides known from GB 809 809, alkali metal salts of enolizable compounds and metal salts of weak aliphatic or cycloaliphatic carboxylic acids, for example sodium methoxide, sodium acetate, potassium acetate, sodium acetoacetate, the basic alkali metal compounds complexed with crown ethers or polyether alcohols that are known from EP-A 0 056 158 and EP-A 0 056 159, for example complexed sodium or potassium carboxylates, the pyrrolidinone-potassium salt known from EP-A 0 033 581.

Further crosslinking catalysts suitable for the process of the invention can be found, for example, in J. H. Saunders and K. C. Frisch, Polyurethanes Chemistry and Technology, p. 94 ff. (1962) and the literature cited therein.

The catalysts B) can be used in the process of the invention either individually or in the form of any desired mixtures with one another.

Preferred catalysts B) are metal compounds of the aforementioned type, especially carboxylates and alkoxides of alkali metals, alkaline earth metals or zirconium, in combination with complexing agents such as crown ethers or polyethylene glycols or polypropylene glycols, and organic tin compounds of the type mentioned.

Particularly preferred crosslinking catalysts B) are sodium and potassium salts of aliphatic carboxylic acids having 2 to 20 carbon atoms in combination with complexing agents such as crown ethers or polyethylene glycols or polypropylene glycols, and aliphatically substituted tin compounds.

Very particularly preferred crosslinking catalysts B) for the process of the invention are potassium acetate in combination with complexing agents such as crown ethers or polyethylene glycols or polypropylene glycols, tin octoate and/or tributyltin oxide. However, the use of tin octoate and/or tributyltin oxide is preferable only when the curing is to be effected within the temperature range up to 50° C. at most.

In the study underlying the present application, it has been found that, surprisingly, the use of tin compounds as described in U.S. Pat. No. 6,133,397 as additional catalysts reduces the hardness of the coating.

Consequently, in a preferred embodiment of the present invention, the reaction mixture on commencement of process step c) contains preferably at most 0.2% by weight, more preferably at least 0.1% by weight and even more preferably at most 0.01% by weight of organic or inorganic iron, lead, tin, bismuth or zinc compounds. These figures are based on the total weight of the reaction mixture. This embodiment is preferred especially when process step c) is conducted not at room temperature but at elevated temperatures, preferably at least 50° C., more preferably at least 80° C. and even more preferably at least 100° C.

The metals in the aforementioned compounds preferably have the respectively typical redox states. These are II for lead, II and III for iron, IV for tin, III for bismuth, and II for zinc. Corresponding iron compounds are preferably iron(II) chloride and iron(III) chloride. Corresponding bismuth compounds are preferably bismuth(III) laurate, bismuth(III) 2-ethylhexanoate, bismuth(III) octoate and bismuth(III) neodecanoate. Corresponding zinc compounds are preferably zinc chloride and zinc 2-ethylcaproate. Corresponding tin compounds are preferably tin(II) octoate, tin(II) ethylcaproate, tin(II) palmitate, dibutyltin(IV) dilaurate (DBTL) and dibutyltin(IV) dichloride. A corresponding lead compound is preferably lead octoate.

In a more preferred embodiment, the contents of the reaction mixture of the abovementioned organic and inorganic tin and bismuth compounds are restricted to the abovementioned concentrations. Most preferably, the content in the reaction mixture of DBTL and bismuth(III) 2-ethylhexanoate is restricted to the abovementioned concentrations.

In the process of the invention, the crosslinking catalyst B) is generally used in a concentration based on the amount of the polyisocyanate composition A) used of 0.0005% to 5.0% by weight, preferably of 0.0010% to 2.0% by weight and more preferably of 0.0015% to 1.0% by weight.

The crosslinking catalysts B) that are used in the process of the invention generally have sufficient solubility in the polyisocyanate composition A) in the amounts that are required for initiation of the crosslinking reaction. The catalyst B) is therefore preferably added to the polyisocyanate composition A) in neat form.

Optionally, however, the catalysts B) can also be used dissolved in a suitable organic solvent to improve their incorporability. The dilution level of the catalyst solutions can be freely selected within a very wide range. Catalytically active catalyst solutions are typically those of a concentration over and above about 0.01% by weight.

Suitable catalyst solvents are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxyprop-2-yl acetate, 3-methoxy-n-butyl acetate, propylene glycol diacetate, acetone, methyl ethyl ketone, methyl isobutyl ketone, cyclohexanone, lactones such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

If catalyst solvents are used in the process of the invention, preference is given to using catalyst solvents which bear groups reactive toward isocyanates and can be incorporated into the polyisocyanurate plastic. Examples of such solvents are mono- or polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethylallyl alcohol or oleyl alcohol; araliphatic alcohols, for example benzyl alcohol; N-monosubstituted amides, for example N-methylformamide, N-methylacetamide, cyanoacetamide or 2-pyrrolidinone, or any desired mixtures of such solvents.

The coatings obtainable by the process of the invention, even as such, i.e. without addition of appropriate auxiliaries and additives C), feature very good light stability. Nevertheless, it is optionally possible to use standard auxiliaries and additives C) as well in the production thereof, for example standard fillers, flatting agents, UV stabilizers, antioxidants, mold release agents, water scavengers, slip additives, defoamers, levelling agents, rheology additives, flame retardants and/or pigments.

These auxiliaries and additives C), excluding fillers and flame retardants, are typically present in the coating in an amount of less than 10% by weight, preferably less than 5% by weight, more preferably up to 3% by weight, based on the polyisocyanate composition A). Flame retardants are typically present in the coating in amounts of not more than 70% by weight, preferably not more than 50% by weight and more preferably not more than 30% by weight, calculated as the total amount of flame retardants used, based on the polyisocyanate composition A).

Apart from the small amounts of any catalyst solvents to be used, the process of the invention is preferably performed in a solvent-free manner. To reduce the processing viscosity, the polyisocyanate composition A) may optionally alternatively be diluted with organic solvents. Solvents suitable for this purpose are, for example, the catalyst solvents inert toward isocyanate groups that have already been described above.

The process of the invention leads to highly converted polymers which are characterized in that the crosslinking reaction of the isocyanates present in the polyisocyanate composition A) is very substantially complete. A crosslinking reaction can be regarded as “very substantially complete” in the context of the present invention when at least 80%, preferably at least 90%, more preferably at least 95%, of the free isocyanate groups originally present in the polyisocyanate composition A) have reacted. In other words, there are preferably not more than 20%, not more than 10%, more preferably not more than 5%, of the isocyanate groups originally present in the polyisocyanate composition A) in the coating of the invention. This can be achieved by conducting the catalytic crosslinking in the process of the invention at least up to a conversion level at which only, for example, not more than 20% of the isocyanate groups originally present in the polyisocyanate composition A) are still present, such that a reaction product with high conversion is obtained. The percentage of isocyanate groups still present can be determined by a comparison of the content of isocyanate groups in % by weight in the original polyisocyanate composition A) with the content of isocyanate groups in % by weight in the reaction product, for example by the aforementioned comparison of the intensity of the isocyanate band at about 2270 cm⁻¹ by means of IR spectroscopy.

A coating created by the process of the invention has extremely advantageous performance properties. Particularly its hardness and its mechanical or chemical stability are greater than known from conventional PU coatings. At the same time, the coating, unlike the isocyanurate polymers described in U.S. Pat. No. 6,133,397 and WO 2015/166983, can be cured at room temperature without any detriment to their advantageous properties. Particularly in the coating of large workpieces, curing at room temperature is advantageous since no ovens that accommodate the entire workpiece are required in this case.

The hardness of a coating is preferably measured as pendulum hardness to DIN EN ISO 1522. A coating “having high hardness” preferably has a König pendulum hardness of at least 100 seconds, more preferably of at least 120 seconds, even more preferably of at least 150 seconds and most preferably of at least 180 seconds.

The mechanical stability of a coating is preferably determined as “nail scratch resistance” or as pencil hardness. Nail scratch resistance is determined by scratching the coating by fingernail. The condition of the surface after the scratching is assessed. Pencil hardness is determined according to DIN EN ISO 15184.

Chemical stability is determined by applying a test fluid containing or consisting of the chemical to be tested to a coated surface and covering it with a petri dish. The incubation that follows is effected at room temperature. After defined time intervals, the coating is examined for discoloration, decoloration, loss of shine, swelling and the presence of blisters. A coating having a high stability shows the aforementioned changes preferably only to a minor degree; more preferably, no change at all is apparent.

The coatings obtainable by the process of the invention especially have elevated stability to ethanol, ink, dilute sodium hydroxide solution, acetone and HS DOT 4 (brake fluid, available from ARAL AG, Germany). HS DOT 4 is a mixture of different polyglycols. This stability is preferably defined in that the surface provided with the coating of the invention does not show any visible changes even after incubation for 16 hours with the aforementioned chemicals.

In addition, the coatings obtainable by the process of the invention have high stability to detergents for removal of spray paint. This stability is preferably defined in that there is no visible impairment of the surface even after 10 applications of a corresponding detergent.

In a further embodiment, the present invention relates to a surface coating obtainable by the process described above.

In yet a further embodiment, the present invention relates to a surface coated with the abovementioned surface coating.

In a further embodiment, the present invention relates to the use of a polyisocyanate composition A) which contains oligomeric polyisocyanates and is low in monomeric polyisocyanates, in the presence of at most 0.5% by weight of organic and inorganic iron, lead, tin, bismuth and zinc compounds in the reaction mixture for production of surface coatings having high mechanical and/or chemical stability.

All definitions that have been given above for the process of the invention—unless stated otherwise—are also applicable to the products and uses of the invention.

In a 1st aspect the present invention relates to a process for producing surface coatings having a high hardness and high mechanical and/or chemical stability, comprising the process steps of
a) providing a polyisocyanate composition A), where the isocyanate content is at least 15% by weight;
b) applying the polyisocyanate composition A) to a surface; and
c) catalytically crosslinking the polyisocyanate composition A) in the presence of a catalyst B).
In a 2nd aspect the present invention relates to the process according to aspect 1, wherein the catalytic crosslinking is effected at room temperature.
In a 3rd aspect the present invention relates to the process according to aspect 1 or 2, wherein the catalyst is a metal salt of a weak aliphatic or cycloaliphatic carboxylic acid in combination with a crown ether.
In a 4th aspect the present invention relates to the process according to any of aspects 1 to 3, wherein the surface coating created has a König pendulum hardness of at least 80 seconds.
In a 5th aspect the present invention relates to the process according to any of aspects 1 to 3, wherein the surface coating created has a König pendulum hardness of at least 100 seconds.
In a 6th aspect the present invention relates to the process according to any of aspects 1 to 5, wherein the surface coating created has elevated chemical stability.
In a 7th aspect the present invention relates to the process according to any of aspects 1 to 6, wherein the coating is particularly stable to at least one of the agents selected from the group consisting of ethanol, ink, sodium hydroxide solution and HS DOT 4.
In an 8th aspect the present invention relates to the process according to any of aspects 1 to 7, wherein, during the catalytic crosslinking in process step c), the amount of the isocyanurate groups in the polyisocyanate composition A) increases by at least 10% compared to the amount that was present in process step a).
In a 9th aspect the present invention relates to a surface coating obtainable by the process according to any of aspects 1 to 8.
In a 10th aspect the present invention relates to a surface coated with the surface coating according to aspect 9.
In an 11th aspect the present invention relates to the surface according to aspect 10, wherein the surface is selected from the group consisting of mineral substances, metal, rigid plastics, flexible plastics, textiles, leather, wood, wood derivatives and paper.
In a 12th aspect the present invention relates to the use of a polyisocyanate composition A) which contains oligomeric polyisocyanates and is low in monomeric polyisocyanates for production of surface coatings having high mechanical and/or chemical stability.

The working examples which follow serve to illustrate the invention. They are not intended to limit the scope of protection of the patent claims in anyway.

### EXAMPLES

Description of the Test Methods

Pendulum hardness analogously to DIN EN ISO 1522:2007-04: the pendulum damping test is a method of determining the viscoelastic properties of coatings to DIN EN ISO 1522 in a pendulum damping instrument and is thus a measure of the hardness thereof. It consists of a sample table on which a pendulum can swing freely on a sample surface and a counter. The number of swings in a defined angle range is a measure of the hardness of a coating and is reported in seconds or number of swings.

Abrasion resistance in the Taber Abraser instrument with CS10 friction rolls (moderate hardness). The coating materials are applied to specimens. After the appropriate curing time, the test is conducted. The specimen (substrate with coating) is weighed and the starting weight is ascertained. The number of friction cycles after which the weight of the specimen and hence the abrasion is weighed is fixed beforehand. The specimen is secured in the sample holder, the friction rolls and suction are applied, and the abrasion test is started. For the determination of abrasion resistance, the weight loss is measured. The specimen is scratched with a fixed number of rotation cycles and the proportion of the sample abraded is ascertained by difference weighing.

Hardness test by DUR-O-Test: The instrument consists of a sleeve into which a spiral spring has been inserted, which can be set to different tensions with the aid of a slide adjuster. The spring acts on a cemented carbide stylus (ø 1 mm), the tip of which projects out of the sleeve. A locking screw fixes the slide adjuster and hence keeps the spring tension constant. In this way, the stylus can be loaded with different force. Three compression springs of different spring force cover a hardness range of 0-20 N. The load that causes a visible scar on the film is ascertained.

Chemical Stability

Coating surface stability to test substance: The cured coating films are examined for their stability to test substances (DIN EN ISO 4628-1 to -5:2016-07). The coating film is generally on a glass plate. A small cottonwool bud is soaked with the test substance and placed onto the coating surface. Evaporation of the test substance is prevented by covering it, for example by means of a watch glass or test tube. The cottonwool bud or cellulose does not dry out. After a contact time fixed beforehand, the bud soaked with test substance is removed, the contact site is dried off, and an immediate assessment is made in order to anticipate regeneration of the paint surface. The test surface is checked for changes visually and by touching by hand. An assessment is then made as to whether and what changes have occurred on the test surface.

Softening and discoloration of the coating surface are assessed.

0=no changes detectable
1=only visible change
2=minor softening/slight change in hue
3=distinct softening/moderate change in hue
4=significant softening/significant change in hue
5=coating completely destroyed without outside action/very significant change in hue

Anti-Graffiti Properties of Surfaces

The cured coating films are assessed for their resistance to graffiti and the corresponding detergents. Paint from a spray can (RAL 4005 blue lilac, RAL 6001 emerald green, RAL 9005 black), Edding 3000 Permanent Marker Red and HS-DOT 4 brake fluid are applied to the painted surface and left to dry at 50° C. for 48 hours. After cooling, AGS 221 graffiti remover surfactant is applied by brush and removed after a contact of 5 minutes. The cycle is repeated up to 10 times and the change is assessed visually, with the following classifications:

0=no changes detectable
1=only visible change
2=minor softening/slight change in hue
3=distinct softening/moderate change in hue
4=significant softening/significant change in hue
5=coating completely destroyed without outside action/very significant change in hue
Sample 0: Clearcoat based on the aliphatic polyisocyanate Desmodur N 3300 (97% by weight) and catalyst (3% by weight). The catalyst mixture contained 0.177 g of potassium acetate, 0.475 g of 18-crown-6 and 3.115 g of diethylene glycol. This catalyst mixture was used for all inventive examples.

### Example 1.1: Pendulum Hardness

Coating Formulations:
Sample 1.1: Clearcoat based on the amino-functional resins Desmophen NH 1450 and Desmophen NH 1520 (1:1) crosslinked with the aliphatic polyisocyanate Desmodur N 3300 with an equivalents ratio of 1.5
Sample 1.2: Clearcoat based on the amino-functional resins Desmophen NH 1450 and Desmophen NH 1520 (1:1) crosslinked with the aliphatic polyisocyanate Desmodur N 3800 with an equivalents ratio of 1.5

Application:

The coatings were applied to various substrates by means of a drawdown bar. After a defined curing time and temperature, pendulum hardness and chemical and mechanical film properties are measured.

Sample 0:

80 μm of wet coating material with spiral coating bar on glass plate, Q-Panel steel and aluminum; curing at 180° C. for 30 minutes and at RT for 7 days

Samples 1.1 and 1.2:

80 μm of wet coating material with spiral coating bar on glass plate, Q-Panel steel and aluminum; curing at RT for 7 days

TABLE 1
Comparison of various coating formulations

| | | Sample 1.1 | |
|---|---|---|---|
| | | Desmophen | Sample 1.2 |
| | | NH 1420/ | Desmophen |
| | Sample 0 | NH 1520 | NH 1420/ |
| | Desmodur | Desmodur | NH 1520 |
| | N 3300 | N 3300 | N 3800 |
| Pendulum hardness | 190 s | 200 s | 55 s |
| (König) | | | |
| after 7 days | | | |
| Scratch resistance | 4N | 1N | <1N |
| (DUR-O-Test) after 28 d | | | |
| Abrasion resistance | 8 mg | 50 mg | 5 mg |
| CS 10, weight 1000 g, | | | |
| 1000 revolutions | | | |
| Chemical stability | | | |
| after 28 days at RT | | | |
| Acetone, 1 min | 0 | 1 | 3 |
| Ethanol, 5 min | 0 | 1 | 2 |
| Ethanol, 50% 30 min | 0 | 1 | 1 |
| Water, 1 h | 0 | 0 | 0 |

### Example 1.2: Curing at Room Temperature

Sample 0 from example 1 was applied to glass plates by means of a drawdown bar. After a defined curing time and curing conditions, pendulum hardness has been determined.

TABLE 2
Properties of the coating materials as a function of
drying temperature

| Coating properties after | | |
|---|---|---|
| different drying conditions | | |
| 50 μm, on glass | 15 min. 150° C. | RT |
| Pendulum hardness (König) after 1 d | 195 s | tacky |
| Pendulum hardness (König) after 7 d | 205 s | 210 s |

### Example 1.3: Chemical Stability

The application test compares the coating of the invention with 2-component polyurethane systems that are recommended for high stabilities.

Coating Materials:
Sample 3.1: 2-component water-based polyurethane clearcoat based on the acrylate polyol Bayhydrol A 2695 crosslinked with the hydrophilized polyisocyanate Bayhydur 304 with an equivalents ratio of 1.5
Sample 3.2: 2-component water-based polyurethane clearcoat based on the acrylate polyol Bayhydrol A 2695 crosslinked with the hydrophilized polyisocyanate Bayhydur 3100 with an equivalents ratio of 1.5

Application:

Sample 0: 50 μm of wet coating material by spiral coating bar onto Makrofol; curing at 180° C. for 15 minutes;

Samples 3.1 & 3.2: 70 μm of wet coating material by spiral coating bar onto Makrofol; curing at 60° C. for 30 minutes and at 60° C. for 960 min

Sample 0 shows no defect in the film even after 10 cycles.

TABLE 3
Chemical stability of the coating materials

| | | Blue | Emerald | Jet | | |
|---|---|---|---|---|---|---|
| | Number | lilac | green | black | | |
| | of | RAL | RAL | RAL | Edding | |
| | cycles | 4005 | 6001 | 9005 | red | HS-DOT |
| Sample 0 | 7 | 0 | 0 | 0 | 0 | 0 |
| Sample 3.1 | 7 | 0 | 0 | 0 | 1 | 5 |
| Sample 3.2 | 7 | 5 | 4 | 5 | 5 | 5 |
| Sample 0 | 10 | 0 | 0 | 0 | 0 | 0 |

### Example 2: Comparative Experiment to Determine the Effect of Dibutyltin Laurate on the Properties of the Coating

The standard temperature is 23° C. All experiments were conducted under standard climatic conditions (SCC), at 23° C. and 50% relative humidity.

Desmodur© BL 3175 SN, Desmodur© BL 4265 SN, Desmodur© BL 3272 MPA, Desmodur© BL 2078/2 SN, Desmodur PL 340 BA/SN and Desmodur© PL 350 MPA/SN are commercially available materials from Covestro AG. They are abbreviated hereinafter to BL 3175, BL 4265, BL 3272 MPA, BL 2078/2 SN, PL 340 BA/SN and PL 350 MPA/SN.

The chemicals used here were sourced from Sigma-Aldrich, unless mentioned otherwise. Commercial products were sourced from the appropriate companies.

The amounts and quantitative ratios used in the experiments are based on the solids content or solids ratio.

Preparation of the Catalyst Composition

Catalyst 1 was prepared by dissolving 1.8 g of 18-crown-6 and 1.2 g of potassium octoate successively in 57 g of methoxypropyl acetate at room temperature. The catalyst was used without further purification.

The deblocking temperature of blocked polyisocyanates can be lowered by addition of suitable catalysts. Accelerated deblocking inevitably enables faster crosslinking of the polyisocyanates. Table 4 summarizes the results of the studies of catalytic deblocking: the addition of DBTL in the presence of example 1 does not lead to faster crosslinking, but reduces the film hardnesses. This is already true of the addition of 0.1% by weight of DBTL and even more clearly for 1.0% by weight of DBTL.

TABLE 4
Effect of DBTL as cocatalyst on curing and crosslinking of the polyisocyanurate
coating compositions. The sample temperature was 220° C., 10 minutes;
oven temperature 250° C.

| | | Ratio | | | |
|---|---|---|---|---|---|
| | | (BL 3175:BL | | Amount | König pendulum |
| No. | Sample | 4265 | Catalyst | (% by wt.) | damping (s) |
| 1 | BL 3175 SN/BL 4265 SN | 10:0 | Cat. 1 | 0.1 | 174 |
| 2 | BL 3175 SN/BL 4265 SN | 9:1 | Cat. 1 | 0.1 | 159 |
| 3 | BL 3175 SN/BL 4265 SN | 8:2 | Cat. 1 | 0.1 | 173 |
| 4 | BL 3175 SN/BL 4265 SN | 5:5 | Cat. 1 | 0.1 | 181 |
| 5 | BL 3175 SN/BL 4265 SN | 2:8 | Cat. 1 | 0.1 | 191 |
| 6 | BL 3175 SN/BL 4265 SN | 10:0 | Cat. 1/DBTL | 0.1/0.1 | 159 |
| 7 | BL 3175 SN/BL 4265 SN | 9:1 | Cat. 1/DBTL | 0.1/0.1 | 162 |
| 8 | BL 3175 SN/BL 4265 SN | 8:2 | Cat. 1/DBTL | 0.1/0.1 | 140 |
| 9 | BL 3175 SN/BL 4265 SN | 5:5 | Cat. 1/DBTL | 0.1/0.1 | 168 |
| 10 | BL 3175 SN/BL 4265 SN | 2:8 | Cat. 1/DBTL | 0.1/0.1 | 173 |
| 11 | BL 3175 SN/BL 4265 SN | 10:0 | Cat. 1/DBTL | 0.1/1 | 87 |
| 12 | BL 3175 SN/BL 4265 SN | 9:1 | Cat. 1/DBTL | 0.1/1 | 135 |
| 13 | BL 3175 SN/BL 4265 SN | 8:2 | Cat. 1/DBTL | 0.1/1 | 95 |
| 14 | BL 3175 SN/BL 4265 SN | 5:5 | Cat. 1/DBTL | 0.1/1 | 118 |
| 15 | BL 3175 SN/BL 4265 SN | 2:8 | Cat. 1/DBTL | 0.1/1 | 164 |

1.-15. (canceled)

16. A process for producing surface coatings having a high hardness and high mechanical and/or chemical stability, comprising the process steps of
a) providing a polyisocyanate composition A), where the isocyanate content is at least 15% by weight;
b) applying the polyisocyanate composition A) to a surface; and
c) atalytically crosslinking the polyisocyanate composition A) in the presence of a catalyst B),
with the proviso that the reaction mixture formed from the polyisocyanate composition A) and the at least one catalyst B) contains not more than 0.2% by weight of organic and inorganic iron, lead, tin, bismuth and zinc compounds.

17. The process as claimed in claim 16, wherein the catalytic crosslinking is effected at a temperature between 10° C. and 35° C.

18. The process as claimed in claim 16, wherein the catalyst is a metal salt of a weak aliphatic or cycloaliphatic carboxylic acid in combination with a crown ether.

19. The process as claimed in claim 16, wherein the catalyst is a metal salt of a weak aliphatic or cycloaliphatic carboxylic acid in combination with a crown ether and the catalytic crosslinking is effected at a temperature between 10° C. and 35° C.

20. The process as claimed in claim 16, wherein the surface coating created has a König pendulum hardness of at least 80 seconds.

21. The process as claimed in claim 16, wherein the surface coating created has a König pendulum hardness of at least 100 seconds.

22. The process as claimed in claim 16, wherein the surface coating created has elevated chemical stability.

23. The process as claimed in claim 16, wherein the coating is particularly stable to at least one of the agents selected from the group consisting of ethanol, ink, sodium hydroxide solution and HS DOT 4.

24. The process as claimed claim 16, wherein, during the catalytic crosslinking in process step c), the amount of the isocyanurate groups in the polyisocyanate composition A) increases by at least 10% compared to the amount that was present in process step a).

25. The process as claimed in claim 16, wherein the reaction mixture formed from the polyisocyanate composition A) and the at least one catalyst B) contains not more than 0.1% by weight of organic and inorganic iron, lead, tin, bismuth and zinc compounds.

26. The process as claimed in claim 16, wherein the molar ratio of isocyanate-reactive groups to isocyanate groups in the reaction mixture on commencement of process step c) is at most 0.3:1.

27. A surface coating obtainable by the process as claimed in claim 16.

28. A surface coated with a surface coating as claimed in claim 27.

29. The surface as claimed in claim 28, wherein the surface is selected from the group consisting of mineral substances, metal, rigid plastics, flexible plastics, textiles, leather, wood, wood derivatives and paper.

30. The use of a polyisocyanate composition A) which contains oligomeric polyisocyanates and is low in monomeric polyisocyanates, in the presence of at most 0.5% by weight of organic and inorganic iron, lead, tin, bismuth and zinc compounds in the reaction mixture for production of surface coatings having high mechanical and/or chemical stability.
